(19) United States
(12) Patent Application Publication
(10) Pub. No.: US 2024/0125189 A1
(43) Pub. Date: Apr. 18, 2024

(54) DRIVE AND STEERING OF A DOWNHOLE ROBOT

(71) Applicant: CALIFORNIA INSTITUTE OF TECHNOLOGY, Pasadena, CA (US)

(72) Inventors: Kristopher V. SHERRILL, Pasadena, CA (US); Jacob F. TIMS, Pasadena, CA (US); Scott J. MORELAND, Pasadena, CA (US)

(21) Appl. No.: 18/277,351

(22) PCT Filed: Mar. 31, 2022
(86) PCT No.: PCT/US2022/022776

§ 371 Date: Aug. 15, 2023

Related U.S. Application Data
(60) Provisional application No. 63/170,385, filed on Apr. 2, 2021.

(51) Int. Cl. E21B 23/00

(52) U.S. Cl. CPC E21B 23/001

(57) ABSTRACT

Systems and methods for driving and steering of a robot, or mobile vessel, for operation in a downhole pipe of an oil/gas/water well are presented. According to one aspect, the mobile vessel includes a plurality of wheels arranged outwardly from the mobile vessel so that each wheel may contact the inner wall of the casing. According to another aspect, the plurality of wheels may include respective wheel-centerlines that intersect the centerline of the casing that is at an offset from a centerline of the mobile vessel. The plurality of wheels includes at least two drive wheels and at least one passive wheel. According to a further aspect, the drive wheels are configured to rotate about their respective wheel-centerlines to steer the mobile vessel during traversal of the casing. In one case, the mobile vessel includes two drive and steering wheels and one passive wheel.

### CROSS REFERENCE TO RELATED APPLICATIONS

The present application claims priority to and the benefit of co-pending U.S. provisional patent application Ser. No. 63/170,385 entitled “Drive and Steering of a Downhole Robot”, filed on Apr. 2, 2021, the disclosure of which is incorporated herein by reference in its entirety.

### STATEMENT OF GOVERNMENT GRANT

This invention was made with government support under Grant No. 80NM00018D0004 awarded by NASA (JPL). The government has certain rights in the invention.

### TECHNICAL FIELD

The present disclosure generally relates to systems and methods for driving and steering of a robot, or mobile vessel, for operation in a downhole pipe, and in particular, for operation in the downhole pipe of an oil-gas producing lateral well.

### BACKGROUND

Detailed information about properties (e.g., physical, chemical, optical properties of, for example, reservoir inflow) in the downhole of an oil-gas producing well, is important to help optimize production and field development. Inflow data points such as oil-gas-water flow rates, pressure, and temperature, for example, are key to understanding the nature of the reservoir properties and the effect of well drilling and completion methods. Although useful, the inflow data are not often measured in real-time, or with considerable frequency (weekly or more frequently), along the lateral section of the well due to technical or cost-prohibitive challenges. Instead, surface well-head production data (total flow rates, pressure, temperature, etc.) are measured for well performance diagnostics and for reporting purposes.

Attempts to instrument the well for real time or at least weekly measurements with continuous electrical or fiber optic cables for powering sensors to measure and deliver physical properties in the downhole of a well have been tested and have not been cost effective. This is particularly true for shale and tight development wells that have, for example, long laterals and multiple perforation entry points of their casing pipe (to contact the rock formation) which then undergo high-pressure hydraulic fracturing to increase hydrocarbon inflows from oil-bearing rock formations. Such harsh activities can easily damage not only the sensors but also power and data cables in the downhole of a well. Furthermore, fracturing of the rock formation may cause residual debris and/or sand to accumulate inside of the casing pipe, thereby rendering travel of a mobile vessel through the casing pipe challenging.

Production-logging tools (PLTs) are used routinely within long, horizontal wells to make measurements of local pressure, temperature, composition and flow rates. PLTs, however, are provided as a service and require well intervention for data to be collected; the operational cost and complexity limiting the frequency the data can be collected within a well.

Unconventional tight rock geologic formations may require a large number of oil/gas wells (holes) drilled in close proximity to each other to effectively extract the hydrocarbon contained in a field. Horizontally-drilled wells may be used in these applications since the hydrocarbon-bearing rock formations tend to exist in stratified layers aligned perpendicular to the gravity vector.

The typical vertical section of these wells can be 1-3 km below the surface and can extend laterally (e.g., in a generally horizontal direction) for distances of, for example, 2-3 km or even more. Oil, natural gas, and water may enter the well at many locations (production intervals/zones open to perforations and fracturing) formed along a lateral distance (e.g., 2-3 km or more) of the well with local flow rates and composition (e.g., oil/water fractions, relative concentrations, hold-up) varying due to inherent geology and the accuracy with which the well intersects (e.g., at the production intervals or sections) the oil-bearing rock formations. In general, information about the performance or hydrocarbon delivery and capacity of a well, such as, for example, flow rate, pressure, and composition, can practically be measured at the surface of the well as-combined values and with little or no knowledge of individual contributions from each of the production intervals or zones. Lack of local information of the inflow details of the well, at, for example, the production intervals or zones, can be a barrier to improving the efficiency of oil-gas extraction from the overall field.

Better knowledge of local interval inflow data across each or multiple entry points (e.g., physical properties such as flow rates, pressure, temperature, etc.) at the downhole of a well (e.g., along the horizontal/lateral section of the well) may help in making better decisions about placement of subsequent perforation/completion intervals for production in a well and/or subsequent drilling of other wells in the field.

For example, an oil production field may have a variety of drilled wells, including an unconventional horizontal oil well that extracts oil from shale and tight formation through a plurality of production intervals or zones (e.g., shown as rectangles in FIG. 1). In order to develop the field, producing the hydrocarbon-bearing rock formations, a number of wells (i.e., holes) may be drilled and spaced, for example, in the order of 500 feet apart from each other. These wells are drilled and completed serially so that information may be gathered from a downhole of a first well, for example, and can aid in determining where to perforate the casing and to apply hydraulic fracturing at selected intervals of the formation in a second and following well. Each such fracturing in turn further increasing the amount of accumulated residual debris and/or sand inside of the casing pipe.

### SUMMARY

Although the present systems and methods are described with reference to wells used in the oil industry, such systems and methods may equally apply to other industries, such as, for example, deep sea exploration or through-ice exploration.

According to one embodiment the present disclosure, a system for measuring properties of a fluid mixture in a casing of a downhole lateral section of a well is presented, the system comprising: a mobile vessel configured for submersion into the fluid mixture in the casing, the mobile vessel comprising: a tubular shape that defines a centerline of the mobile vessel; and a plurality of wheels having respective plurality of wheel-centerlines, the plurality of wheels protruding the tubular shape according to directions defined by the respective plurality of wheel-centerlines for contacting the casing, wherein each of the plurality of wheel-centerlines is configured to intersect a centerline of the casing, and the centerline of the mobile vessel is configured to be at an offset from the centerline of the casing.

According to a second embodiment of the present disclosure, a mobile vessel for traversing a horizontal casing, the mobile vessel comprising: a tubular shape that defines a centerline of the mobile vessel; and a plurality of wheels having respective plurality of wheel-centerlines, the plurality of wheels protruding the tubular shape according to directions defined by the respective plurality of wheel-centerlines for contacting the horizontal casing, wherein each of the plurality of wheel-centerlines is configured to intersect a centerline of the horizontal casing, the centerline of the mobile vessel is configured to be at an offset from the centerline of the horizontal casing, the plurality of wheels includes at least two drive wheels that rotate about respective rotation axes that are perpendicular to the respective wheel-centerlines, and the plurality of wheels includes at least one steering wheel that rotates about the respective wheel-centerline.

According to a third embodiment of the present disclosure, a method for traversing a casing that includes piles of debris and/or sand using the mobile vessel according to the above is presented, the method comprising: providing a mobile vessel according to the above; integrating an orientation sensor in the mobile vessel; activating the at least two drive wheels of the mobile vessel, thereby starting a traversal of the mobile vessel through the casing; and based on measurements obtained from the orientation sensor, controlling the at least one steering wheel to guide the centerline of the mobile vessel above the centerline of the casing, thereby obtaining a normal orientation of the mobile vessel, the normal orientation based on alignment of the centerlines of the mobile vessel and the casing with a gravity vector, g.

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates a cross sectional view of an example known oil production field, comprising one or more drilled wells for production of oil and/or gas in which a mobile vessel constructed in accordance with this disclosure may be disposed.

FIG. 2 shows a lateral section of a well of the oil production field shown in FIG. 1 comprising a plurality of production zones in which a mobile vessel constructed in accordance with this disclosure may be used.

FIG. 3 shows a mobile vessel positioned in a lateral section of a well of the oil production field shown in FIG. 1.

FIG. 4 shows a mobile vessel according to an exemplary embodiment of the present disclosure positioned in a lateral section of a well of the oil production field shown in FIG. 1.

FIG. 5A shows a front view of the mobile vessel of FIG. 4 positioned at a reference angular position.

FIG. 5B shows details of wheels according to an embodiment of the present disclosure used in the mobile vessel of FIG. 5A, including driving axes of rotation of the wheels and respective contacts to the casing.

FIG. 5C shows details of the wheels according to another embodiment of the present disclosure used in the mobile vessel of FIG. 5A, including extended lengths of the wheels.

FIG. 5D shows details of the wheels according to an embodiment of the present disclosure used in the mobile vessel of FIG. 5A, including relative position of the wheels and relative position of the mobile vessel to the casing.

FIG. 6A shows front views of the mobile vessel of FIG. 4 positioned at different angular positions.

FIG. 6B shows details of the wheels according to an embodiment of the present disclosure used in the mobile vessel of FIG. 5A, including steering of the wheels.

FIG. 7A shows a side view of the mobile vessel of FIG. 4, including a position of a wheel during normal travel through the casing.

FIG. 7B shows a side view of the mobile vessel of FIG. 4, including a position of a wheel during steering through the casing.

FIG. 8A shows the mobile vessel of FIG. 4 within a casing pipe of a lateral well, including a retractable sensor in a nose of the mobile vessel.

FIG. 8B shows the mobile vessel of FIG. 4 within a casing pipe of a lateral well, including a sensor arranged in a main body of the mobile vessel.

FIG. 8C shows an example embodiment of another mobile vessel including a sensor.

Like reference numbers and designations in the various drawings indicate like elements.

### DETAILED DESCRIPTION

As set forth above, information may be gathered from a downhole of a first well, for example, and can aid in determining where to perforate the casing and to apply hydraulic fracturing at selected intervals of the formation in a second and following well. It is understood that the downhole of an oil well may include a (multiphase, non-homogeneous) fluid mixture that may include different components having different phases in dependence of different thermodynamic conditions, the different phases including a liquid phase and a gaseous phase. Systems and methods according to the present disclosure allow measurement/sensing of physical properties in a lateral section of the downhole via a mobile vessel that can travel through the casing in spite of accumulated debris and/or sand.

In particular, presented herein is a mobile vessel that may be controlled within the casing to stay above the accumulated debris and/or sand. Piles of debris and/or sand that may accumulate high enough to touch the mobile vessel or interfere with a main body of the mobile vessel, may be smoothened out by the motion of the mobile vessel, and redistributed throughout the casing. According to an embodiment of the present disclosure, the mobile vessel may be configured to include a centerline that may not be concentric with a centerline of the casing. According to an embodiment of the present disclosure, the mobile vessel may include a substantially tubular shape about the centerline of the mobile vessel, the tubular shape having a main longitudinal extension that during a traversal of the casing may be remain substantially parallel to the centerline of the casing. According to an embodiment of the present disclosure, an offset between the centerline of the mobile vessel and the centerline of the casing may be configured to position the mobile vessel farther above the accumulated debris and/or sand inside of the casing.

According to an embodiment of the present disclosure, the mobile vessel may include a plurality of wheels arranged outwardly from the mobile vessel so that each wheel may contact (the inner wall of) the casing. According to an embodiment of the present disclosure, the plurality of wheels may include respective wheel-centerlines that intersect the centerline of the casing. According to an embodiment of the present disclosure, the wheel-centerlines are concentric with the casing. According to an embodiment of the present disclosure, the wheel-centerlines are radially disposed with respect to the centerline of the casing. According to an embodiment of the present disclosure, respective angular positions of the wheels relative to a reference angular position are configured to substantially clear the wheel from the accumulated debris and/or sand. According to an exemplary embodiment of the present disclosure, the reference angular position may be according to a direction of the gravity vector, and therefore perpendicular to the horizontal direction of the casing.

According to an embodiment of the present disclosure, the plurality of wheels may include at least two drive wheels (actively driven) and at least one passive wheel (not actively driven). According to an embodiment of the present disclosure, the at least two drive wheels may be configured to rotate in either positive or negative angular directions for motion of the mobile vessel in either toe or heel sections of the well. According to an embodiment of the present disclosure, respective rotation axes of the wheels are perpendicular to the respective wheel-centerlines, the wheel-centerlines contained within respective rotation planes of the wheels. According to an exemplary embodiment of the present disclosure, at least two of the wheel-centerlines may be arranged in a same plane that is perpendicular to the centerline of the casing. According to an exemplary embodiment of the present disclosure, all of the wheel-centerlines may be arranged in a same plane that is perpendicular to the centerline of the casing, or in other words, the wheel-centerlines may be coincide (collocated) in the longitudinal direction of the mobile vessel. According to an exemplary embodiment of the present disclosure, none of the wheel-centerlines may be arranged in a same plane that is perpendicular to the centerline of the casing, or in other words, the wheel-centerlines may be offset in the longitudinal direction of the mobile vessel.

According to an exemplary embodiment of the present disclosure, during normal traversal of the casing, the wheel-centerline of the passive wheel may be at the reference angular position. According to an embodiment of the present disclosure, the wheel-centerline of the passive wheel may be maintained at the reference angular position by steering corrections performed by the wheels. According to an embodiment of the present disclosure, the mobile vessel may include an orientation sensor to sense orientation of the mobile vessel, or in other words, to sense angular position of the wheel-centerline of the passive wheel relative to the reference angular position (e.g., gravity vector). According to an exemplary embodiment of the present disclosure, the orientation sensor may include a magnetometer and/or an accelerometer.

According to an exemplary embodiment of the present disclosure, one or more of the wheels may be configured to steer. According to an exemplary embodiment of the present disclosure, the drive wheels may be configured to steer. According to an exemplary embodiment of the present disclosure, the at least one passive wheel may be configured to steer. According to an embodiment of the present disclosure, steering of a wheel may be according to a rotation of the wheel about the respective wheel-centerline. In other words, the wheel-centerline defines a steering axis of the wheel.

According to an exemplary embodiment of the present disclosure, the at least one passive wheel may be spring loaded so to provide necessary normal (to the casing) force to either lift the mobile vessel off the bottom of the casing when upside down or to provide friction for driving the mobile vessel upwards slopes of the casing and/or over slippery areas within the casing. According to an exemplary embodiment of the present disclosure, any one or more of the wheels may be spring loaded. According to an embodiment of the present disclosure, the combination of the relative placement of the wheel-centerlines with the centerline of the casing, the offset between the centerline of the mobile vessel and the centerline of the casing, and the steering of the wheels about the respective wheel-centerlines, may allow the mobile vessel to traverse the casing according to a helical path (e.g., spiral, corkscrew trajectory/path).

Teachings according to the present disclosure may be independent of a type of mobile vessel, whether a fully instrumented autonomous robot, or a remote or wired vessel, so long it can be operable in the harsh environment of the downhole of an oil pipe, including operable to travel along the lateral section of the oil well, position at any location along the lateral section of the oil well, and use embedded sensors to measure/sense the physical properties in the lateral section of the oil well.

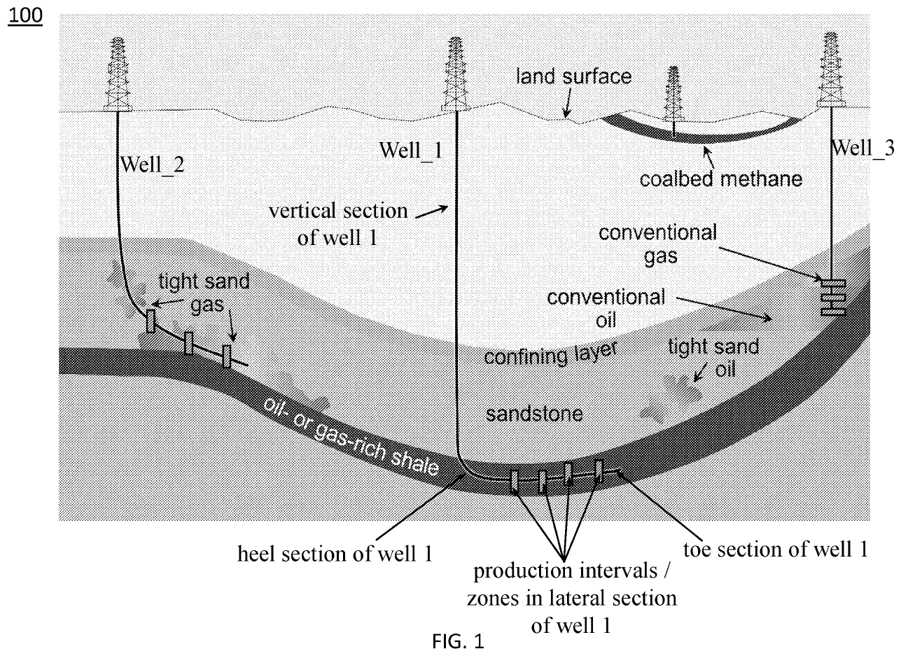

The mobile vessel described herein may be used in a number of settings, an example of which is depicted in FIG. 1, which illustrates a cross sectional view of an example oil production field (100), comprising one or more drilled wells (Well_1, Well_2, . . . ) for production and extraction of oil and/or gas from various regions of the field. In particular, as can be seen in FIG. 1, a vertical section of the Well_1 may be drilled to reach and penetrate an oil- or gas-rich shale (e.g., rock formation), and a lateral (e.g., horizontal) section of the Well_1, which, in the example case of FIG. 1 is substantially horizontal, may be drilled along the shale, starting from a heel section of the Well_1, and ending at a toe section of the Well_1. Generally, the vertical section of the Well_1 may extend 1 to 3 km below the surface and the lateral section of the Well_1 may extend for distances of, for example, 2-3 km or more.

With continued reference to FIG. 1, fluid mixtures, including (crude) oil, water, and/or natural gas mixtures, may enter the Well_1, for example, through open-hole or a casing of the Well_1, at production perforated intervals/zones that may be formed in the lateral section of the Well_1. Furthermore, along with the fluid mixtures, residual debris and/or sand from the perforated intervals/zones may enter the casing of the Well_1. Each of such production intervals/zones may include holes and/or openings that extract the fluid from the shale and route into the casing of the Well_1. As shown in FIG. 1, the perforated intervals/production zones may be separated by distances of, for example, about 100 meters (e.g., about 300 feet), and between each of the intervals (or stages) there are several clusters of perforations with closer spacing in order to cover a lengthy lateral and extract more hydrocarbon from shale/tight formations. Since there are many production zones, the inflow contribution for each of the intervals (or zones or clusters), such as, for example, local pressure, temperature, flow rates, and composition, may vary due to inherent geology and the accuracy with which the lateral section of the Well_1 intersects the oil-bearing rock formations at the production zones.

Collecting data at regions of the Well_l, for example close to each of the production zones, can help evaluate effectiveness of inflow contribution for each of the production zones and further help in optimizing production (e.g., by altering the perforation/completion design). When integrated with a mobile vessel as described herein, various sensors, such as for example, flow velocity, composition, pressure and temperature sensors, may be used to determine physical properties of each fluid component of a multiphase flow at each of the production zones formed in the lateral section of the Well_1, in spite of any accumulated (piles of) debris and/or sand inside of the casing.

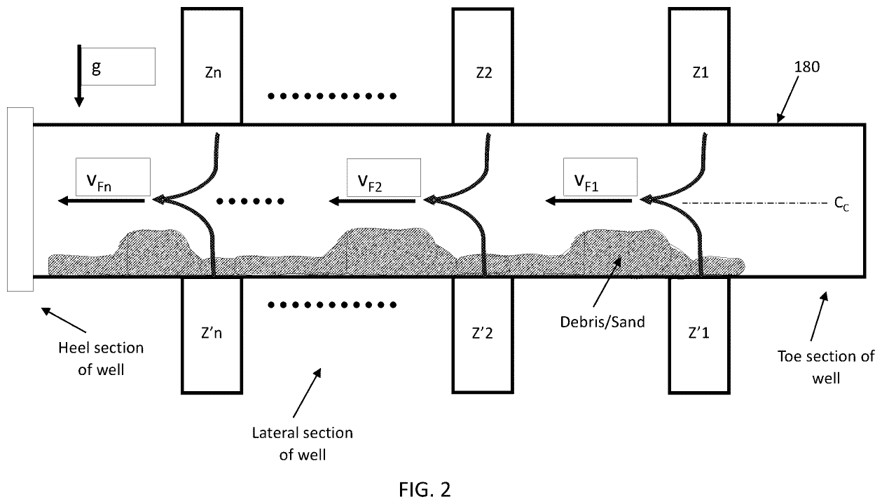

FIG. 2 shows a lateral section of a well of the oil production field shown in FIG. 1 comprising a plurality of production zones indicated as (Z1, Z′1, . . . , Zn, Z′n) and related accumulation of debris and/or sand in the casing (180). As shown in FIG. 2, the casing (180) may include a longitudinal extension that is defined by a centerline (i.e., center axis), C_{C}, of the casing (180) that is perpendicular to the gravity vector, g. Also shown in FIG. 2 are local fluid velocity vectors (V_{F1}, . . . , V_{Fn}) at vicinity of respective production zones. For example, the fluid velocity vector V_{F1}, may be considered solely based on an inflow (of fluid) contribution by the last production zone (Z1, Z′1) close to the toe section of the well. On the other hand, the fluid velocity vector V_{F2} may be considered based on a combination of the inflow contribution of the production zone (Z2, Z′2) combined with the inflow contribution of the last production zone (Z1, Z′1). A performance of each of the production zones (Z1, Z′1, . . . , Zn, Z′n) based on a corresponding inflow contribution may be assessed by, for example, positioning a mobile vessel including one or more sensors about each of the production zones (Z1, Z′1, . . . , Zn, Z′n), and measuring/estimating via the one or more sensors, a difference between a mass flow rate of a fluid component before and after each production zone.

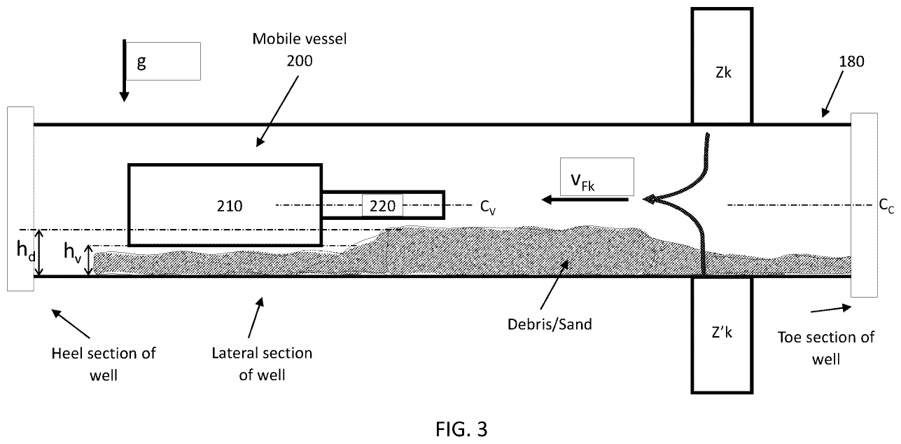

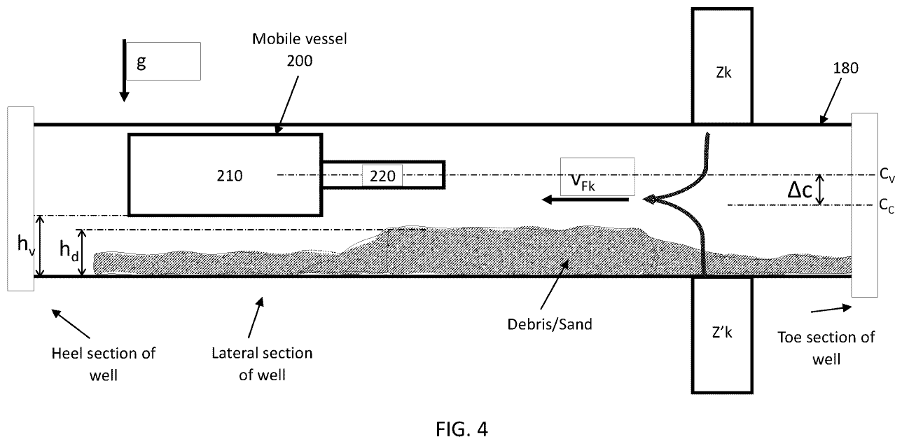

FIG. 3 shows a mobile (e.g., submersion) vessel (200) comprising, for example, first and second elements (210, 220), the mobile vessel (200) positioned downstream (e.g., towards the heel section of the well) of the production zone (Zk, Z′k) in a lateral section of a well of the oil production field shown in FIG. 1. As shown in FIG. 3, when traveling along (i.e., traversing) the casing (180), travel/motion of the mobile vessel (180) may be impeded by accumulated debris and/or sand in the casing according to piles of various heights. For example, if an available clearance of the mobile vessel (200) to the base of the casing (180) is provided by a vessel clearance height, hᵥ, any pile of a height that is greater than the vessel clearance height, hᵥ, may impede the travel/motion of the mobile vessel (180). In particular, as shown in FIG. 3, a pile of debris and/or sand of height, h_{d}, that is greater than, hᵥ, may be present about (e.g., downstream of) the production zone (Zk, Z′k). In some cases, the height, h_{d}, of a pile may be large enough to completely stop the motion of the mobile vessel (180), either by mechanical interference or lack of motion force and/or grip to move the mobile vessel (180) past the pile. In some cases, the mobile vessel (180) may have enough motion force and/or grip to initially push debris and/or sand that make a pile (or portion thereof), but such pushing may gradually increase a resistance against the motion of the mobile vessel (180) causing the vessel to completely stop. Teachings according to the present disclosure circumvent problem arising from presence high piles in the casing by off centering the mobile vessel (180) within the casing (180). In other words, a centerline (i.e., center axis), C_{V}, of the mobile vessel (180) may be at an offset relative to the centerline, C_{C}, of the casing (180). This is shown in FIG. 4.

FIG. 4 shows a mobile vessel (200) according to an exemplary embodiment of the present disclosure, the mobile vessel (200) positioned in a lateral section of a well of the oil production field shown in FIG. 1. As shown in FIG. 4, by positioning (the centerline C_{V} of) the mobile vessel (200) at an offset, Δc, relative to the centerline, C_{C}, of the casing (180), the mobile vessel (200) may clear a high pile having a height, h_{d}, In other words, the offset, Δc, between the centerline of the mobile vessel, C_{V}, and the centerline of the casing, C_{C}, may be configured to position the mobile vessel (200) farther above the accumulated debris and/or sand inside of the casing (180). Accordingly, the mobile vessel (200) according to the present teachings may traverse the full longitudinal extension of the casing (180) for measurement/sensing of the downhole physical properties at any of the production zones (e.g., Z1, Z′1, . . . , Zn, Z′n of FIG. 2). An amount of the offset, Δc, may define the vessel clearance height, hᵥ, and may be based on prior knowledge of typical pile height distribution along a casing of a downhole pipe. Although the offset, Δc, may not allow full clearance of all pile heights encountered, it may allow pushing and redistributing the relatively small amounts of debris and/or sand at the top of the piles that may hit the mobile vessel (200).

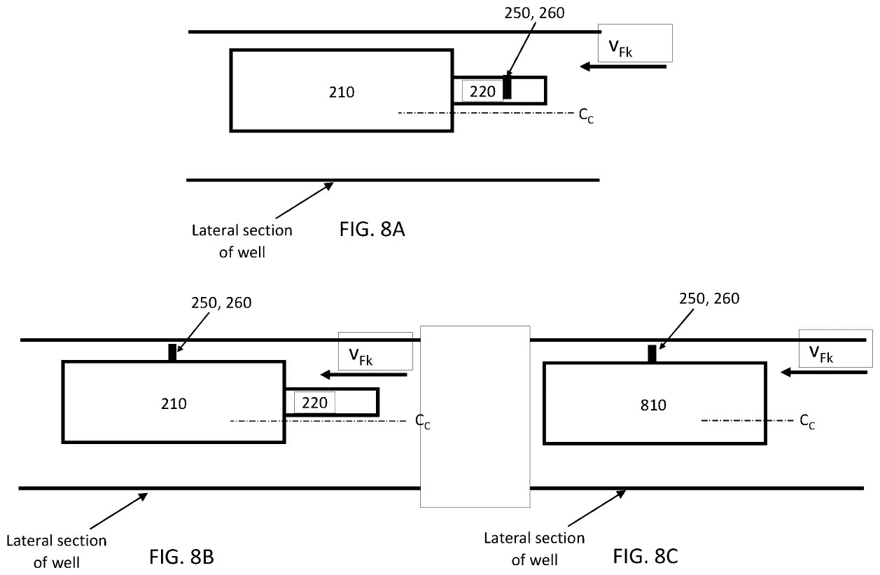

With continued reference to FIG. 4, the center axis, C_{C}, of the mobile vessel (200) may be a common axis of the elements (210) and (220) of the mobile vessel (200) or may be an axis that is different from (e.g., parallel to) a center axis of the element (210, e.g., main body) of the mobile vessel. According to some example embodiments, the elements (210) and (220) of the mobile vessel may include a tubular or cylindrical shape about the center axis, C_{C}, or about a respective center axis. In some embodiments, any one of the elements (210) or (220) may include one or more sensors (e.g., FIGS. 8A-8C later described) used for measurement/sensing of the physical properties in the lateral section of the downhole. According to some embodiments, the element (220) may be referred to a nose of the mobile vessel (200) and may be configured to rotate about its center axis for azimuthal profile measurements/sensing. According to some embodiments, the mobile vessel (200) may include only one element (210).

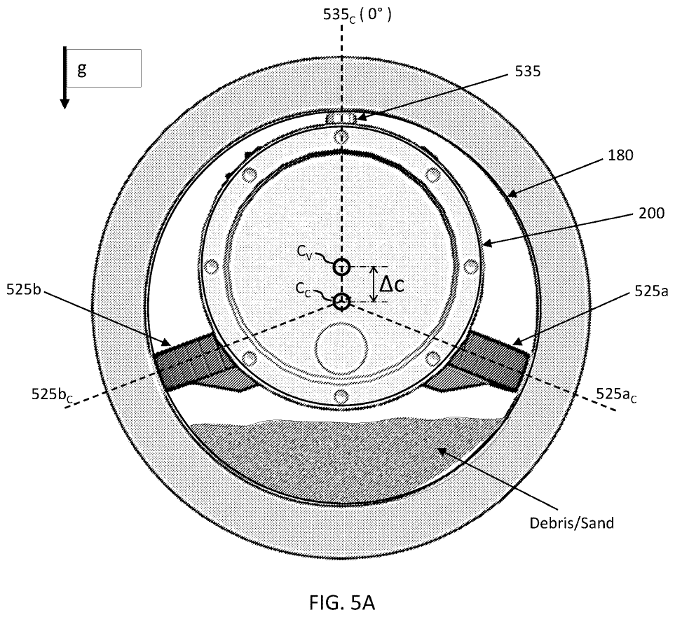

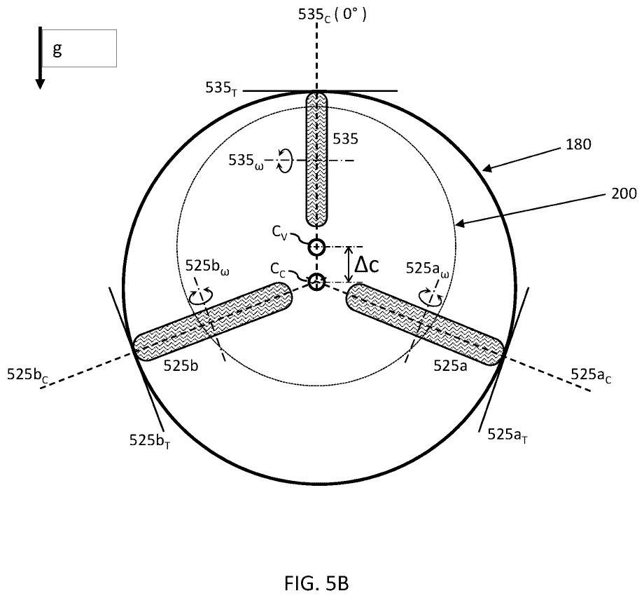

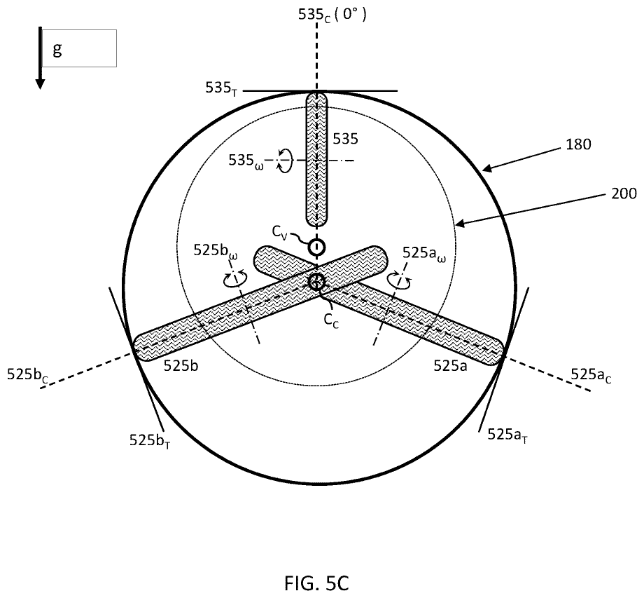

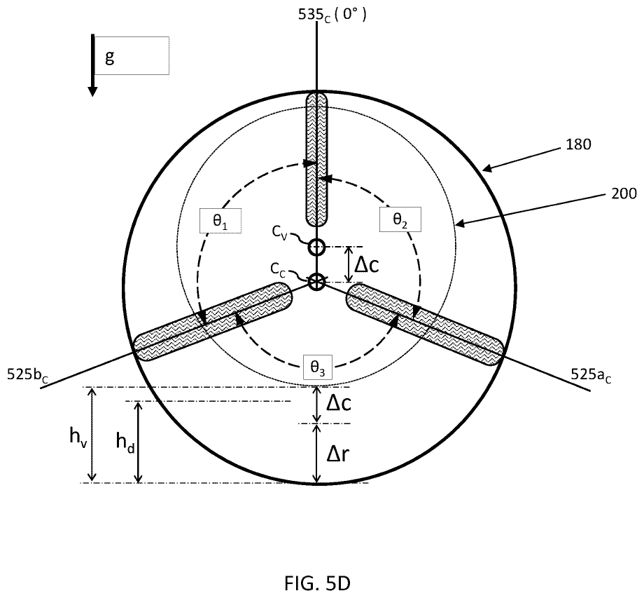

FIG. 5A shows a front view of the mobile vessel of FIG. 4 positioned at a reference angular position (e.g., 0°). According to an embodiment of the present disclosure, the mobile vessel (200) may include a plurality of wheels (525a, 525b, 535) arranged (e.g., protruding) outwardly from the mobile vessel (200) so that each wheel may contact (the inner wall of) the casing (180). According to an embodiment of the present disclosure, the plurality of wheels (525a, 525b, 535) may include respective wheel-centerlines (525a_{c}, 525b_{c}, 535_{c}) that, as shown in FIG. 5A, intersect the centerline, C_{C}, of the casing (180). In other words, the wheel-centerlines (525a_{c}, 525b_{c}, 535_{c}) may be arranged radially about the centerline, C_{C}, of the casing (180). In other words, the wheel-centerlines (525a_{c}, 525b_{c}, 535_{c}) may be concentric with the casing (180).

FIG. 5B shows details of the wheels (525a, 525b, 535) according to an embodiment of the present disclosure used in the mobile vessel (200) of FIG. 5A. In particular, FIG. 5B shows details of respective rotation axes (525a_{ω}, 525b_{ω}, 535_{ω}) of the wheels (525a, 525b, 535). As shown in FIG. 5B, the respective rotation axes (525a_{ω}, 525b_{ω}, 535_{ω}) may be perpendicular to the respective wheel-centerlines (525a_{c}, 525b_{c}, 535_{c}), the wheel-centerlines (525a_{c}, 525b_{c}, 535_{c}) contained within respective rotation planes of the wheels (525a, 525b, 535).

According to a nonlimiting embodiment of the present disclosure, the plurality of wheels (525a, 525b, 535) shown in FIG. 5B may include at least two drive wheels (525a, 525b) and at least one passive (not actively driven) wheel (535). According to an embodiment of the present disclosure, the at least two drive wheels (525a, 525b) may be configured to rotate in either positive or negative angular directions for motion of the mobile vessel (200) in either toe or heel sections of the well. According to a nonlimiting exemplary embodiment of the present disclosure, the at last two drive wheels (525a, 525b) may be larger than the at least one passive wheel (535). In other words, respective extensions of the at least two drive wheels (525s, 525b) along their respective wheel-centerlines (525a_{c}, 525b_{c}) may be greater than the extension of the at least one passive wheel (535) along its wheel-centerline (535_{c}).

According to an embodiment of the present disclosure, the reference angular position of the mobile vessel (200), or in other words, its orientation within the casing (180), may be based on an angular position of the passive wheel (535). According to an exemplary embodiment of the present disclosure, the orientation of the mobile vessel (200) may be based on a direction of the wheel-centerline (5350 relative to the gravity vector, g. According to an exemplary embodiment of the present disclosure, the reference angular position, annotated in the figures as, 0°, may be based on the direction of the wheel-centerline (5350 being parallel to the gravity vector, g. It should be noted that the above described arrangement of the wheels (525a, 525b, 535) relative to the centerline, C_{C}, of the casing (180), may result in a contact point of each wheel (525a, 525b, 535) at the circumference of the inner wall of the casing (180) that can be defined by an intersection of the wheel-centerlines (525a_{c}, 525b_{c}, 535_{c}) with a respective tangent (525a_{T}, 525b_{T}, 535_{T}) to the circumference of the inner wall of the casing (180). In this case, as shown in FIG. 5B, the wheel-centerlines (525a_{c}, 525b_{c}, 535_{c}) may be perpendicular to the respective tangents (525a_{T}, 525b_{T}, 535_{T}).

As shown in FIG. 5B, according to an exemplary embodiment of the present disclosure, at least two of the wheel-centerlines (525a_{c}, 525b_{c}, 535_{c}) may be arranged in a same plane (e.g., plane of the figure) that is perpendicular to the centerline, C_{C}, of the casing (180). Such arrangement may be feasible when the longitudinal/radial extension of the wheels (e.g., any two of 525a, 525b, 535) do not cause the wheels to cross the centerline, C_{C}. For example, in the exemplary case shown in FIG. 5B, a longitudinal extension (e.g., size) of each of the wheels (525a, 525b, 535) along their respective wheel-centerlines (525a_{c}, 525b_{c}, 535_{c}) is short enough not to interfere with the longitudinal extension of any other wheel. This in turn may allow, if desired, any two, or all, of the wheels to be (substantially) collocated along a longitudinal extension of the mobile vessel (200). However, such arrangement may not be possible in some implementations, due for example, to required sizes of the wheels in view of a diameter of the casing and/or the mobile vessel (200).

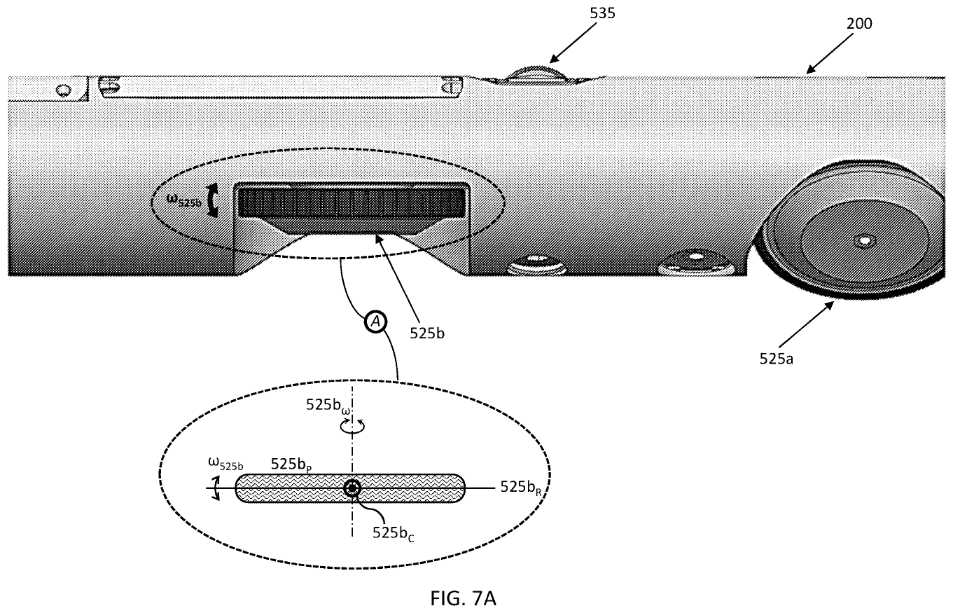

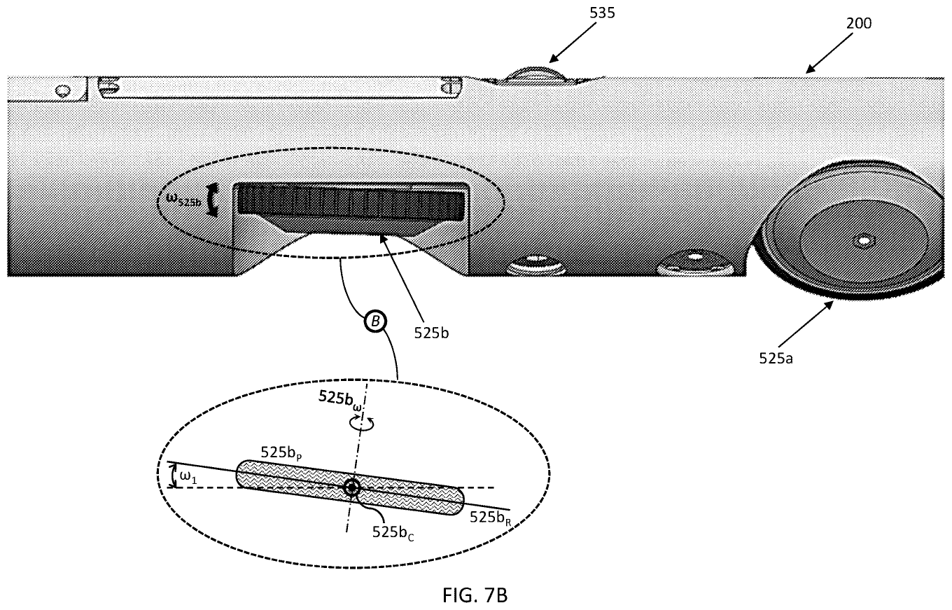

It follows that according to an exemplary embodiment of the present disclosure, as shown in FIG. 5C, at least two of the wheel-centerlines (e.g., any two of 525a_{c}, 525b_{c}, 535_{c}), including for example all of the wheel-centerlines (525a_{c}, 525b_{c}, 535_{c}), may be arranged in respective different planes, each perpendicular to the centerline, C_{C}, of the casing (180). In other words, the wheel-centerlines (525a_{c}, 525b_{c}, 535_{c}) may be offset in the longitudinal direction of the mobile vessel (200) so to avoid interferences between the wheels (e.g., shown in FIGS. 7A-7B later described).

FIG. 5D shows details of the wheels (525a, 525b, 535) according to an embodiment of the present disclosure used in the mobile vessel (200) of FIG. 5A, including relative (angular) position of the wheels (525a, 525b, 535) and relative position (e.g., offset) of the mobile vessel (200) to the casing (180). In particular, as shown in FIG. 5D, the offset, Δc, between the centerlines (C_{V}, C_{C}) may be based on a difference radius, Δr, between a radius of the casing (180) and a radius (of the main body) of the mobile vessel (200), and a desired vessel clearance height, hᵥ, for clearing a pile height, h_{d}, According to a nonlimiting embodiment of the present disclosure, the offset, Δc, may be provided such that a sum of the difference radius, Δr, and the offset, Δc, is equal to the desired vessel clearance height, hᵥ.

With continued reference to FIG. 5D, according to an exemplary embodiment of the present disclosure, the wheels (e.g., 525a, 525b, 535) of the mobile vessel (200) may include three wheels (525a, 525b, 535) arranged radially to the centerline, C_{C}, with respective wheel-centerlines (525a_{c}, 525b_{c}, 535) positioned at relative angular positions (defined by angular distances represented by angles θ₁, θ₂, θ₃). According to an exemplary nonlimiting embodiment of the present disclosure, the angles θ₁ (between wheel-centerlines 535_{c} and 525b_{c}) and θ₂ (between wheel-centerlines 535_{c} and 525a_{c}) may be equal. According to an exemplary nonlimiting embodiment of the present disclosure, the angle θ₃ (between wheel-centerlines 525a_{c} and 525b_{c}) may be different from the angle θ₁ and from the angle θ₂. According to an exemplary nonlimiting embodiment of the present disclosure, the angles θ₁ and θ₂ may each be in a range from about 100° to about 115°. According to an exemplary nonlimiting embodiment of the present disclosure, the angle θ₃ may be in a range from about 130° to about 160°.

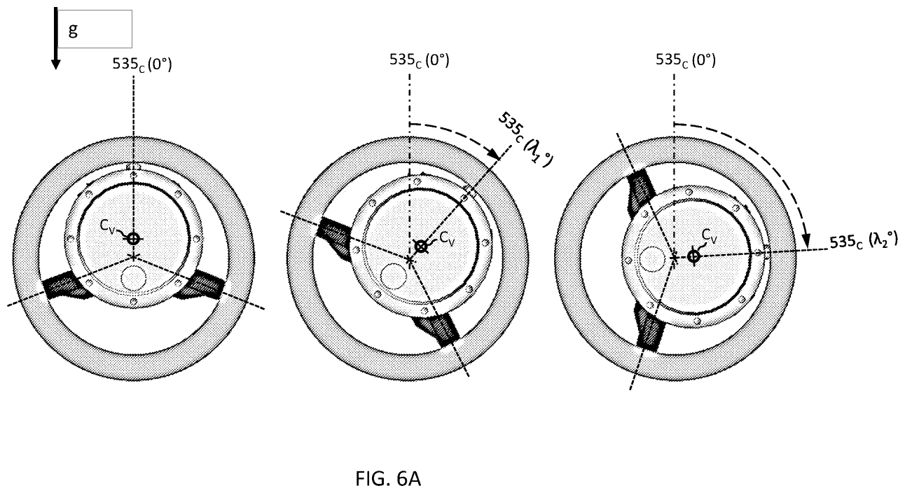

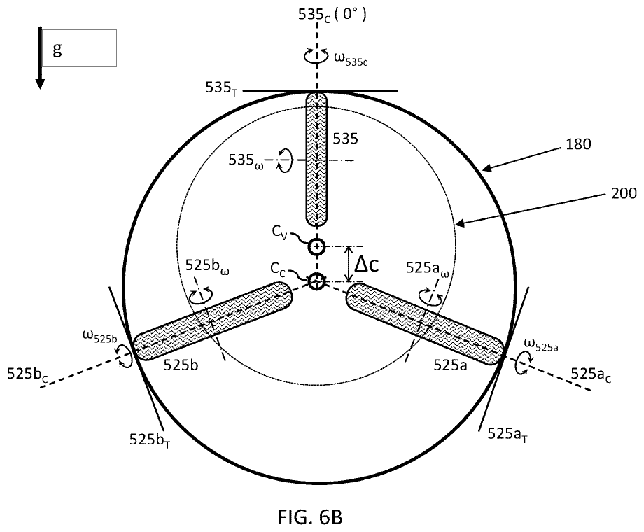

FIG. 5D shows the (expected) orientation of the mobile vessel (200) during normal operation (e.g., normal travel). In particular, during normal operation, the wheel (535, e.g., passive wheel) may be positioned such that direction of the corresponding wheel-centerline (535) is at the 0° mark, or in other words, parallel to the gravity vector, g, and therefore perpendicular to the horizontal/longitudinal direction of the casing (180). Furthermore, as shown in FIG. 5D, during normal operation, or in other words, normal orientation, the centerline, C_{V}, of the mobile vessel (200) may be above the centerline, C_{C}, of the casing (180), or in other words, the centerline, C_{V}, may be farther distant from a base/bottom of the casing (180) when compared to the centerline, C_{C}. According to an exemplary embodiment of the present disclosure, as shown in FIG. 5D, during normal orientation, the centerline, C_{V}, of the mobile vessel (200) and the centerline, C_{C}, of the casing (180), may be aligned with the gravity vector, g. In other words, a vector representative of the offset distance, Δc, between the centerlines (C_{V}, C_{C}) may be aligned/parallel with/to the gravity vector, g. Accordingly, during travel/motion, due, for example, in part to the offset between a center of gravity of the mobile vessel (200) and the center of the wheels (e.g., intersection of the wheel-centerlines at center of the casing), and in part to the slopes of the inner wall of the casing (180), the mobile vessel (200), or its center of gravity, may exhibit tendency to drift/rotate about the centerline, C_{C}, of the casing (180). Such tendency to drifting/rotation of the vessel (200) is shown in FIG. 6A, including a normal position with alignment with the 0° mark at the left of FIG. 6A, and gradual/increasing drifting/rotation at respective (angular) positions λ₁° and λ₂° relative to the normal position at center and right regions of FIG. 6A.

It follows that according to an embodiment of the present disclosure, the normal position/orientation of the mobile vessel may be maintained by steering corrections performed by any one or more of the wheels (525a, 525b, 535). For example, the wheel-centerline (5350 of the passive wheel (535) may be maintained at the reference angular position (i.e., 0° mark) by steering corrections performed by any one or more of the wheels (525a, 525b, 535). According to an embodiment of the present disclosure, the mobile vessel may include an orientation sensor to sense orientation of the mobile vessel, or in other words, to sense the angular position of a reference wheel-centerline, such as, for example, of the passive wheel (535), relative to a reference angular position (e.g., gravity vector, g). For example, the angular position of the passive wheel (535) relative to the reference angular position (i.e., 0° mark) may be sensed by the orientation sensor, and corresponding steering correction to maintain the reference angular position may be provided to the one or more steering wheels (e.g., one or more of 525a, 525b, 535). According to an exemplary embodiment of the present disclosure, the orientation sensor may include a magnetometer and/or an accelerometer arranged within the mobile vessel (200).

According to a nonlimiting embodiment of the present disclosure, the wheels (525a, 525b) may be drive and steering wheels. According to a nonlimiting embodiment of the present disclosure, the wheel (535) may be a passive wheel that may be configured to steer or not steer (e.g., responsive to the steering of the wheels 525a, 525b). According to a nonlimiting embodiment of the present disclosure, the wheel (535) may be a drive wheel that may be configured to steer or not steer.

With reference to FIG. 6B, according to an embodiment of the present disclosure, steering of a wheel (e.g., 525a, 525b, 535) may be according to a rotation of the wheel about the respective wheel-centerline (e.g., 525a_{c}, 525b_{c}, 535_{c}). In other words, the respective wheel-centerline (e.g., 525a_{c}, 525b_{c}, 535_{c}) may define a respective steering axis of the wheel about which the wheel may rotate by a respective angle (ω₅₂₅ₐ, ψ_{525b}, ω₅₃₅). Such steering, when available for more than one of the wheels (e.g., 525a, 525b, 535) may be performed in unison to obtain the intended correction, thereby maintaining the mobile vessel (200) in its normal orientation.

FIG. 7A shows a side view of the mobile vessel (200) of FIG. 4, including a position of a wheel during normal travel through the casing (200). Since during normal travel, orientation of the mobile vessel (200) may not require a correction, then as shown in FIG. 7A, a steering wheel (e.g., 525b) may be kept straight, and therefore may not be rotated about the respective wheel-centerline (e.g., 525b_{c}). In particular, detail A of FIG. 7A shows: a direction of the respective wheel-centerline (e.g., 525b_{c}) as being perpendicular to the plane of the figure (e.g., a dot); a projection of the wheel (e.g., 525b_{P}) onto the plane of the figure as being a longitudinal profile (e.g., diameter of the wheel) along the horizontal direction of the figure that includes a rotation plane of the wheel (e.g., 525b_{R}) that is, and remains, perpendicular to the rotation axis of the wheel (e.g., 525b_{ω}); and a rotation (e.g., ω_{525b}) of the wheel (e.g., 525b) about the respective wheel-centerline (e.g., 525b_{c}) as being zero. As shown in the detail B of FIG. 7B, when the steering wheel (e.g., 525b) is articulated/engaged, the projection of the wheel (e.g., 525b_{P}), the rotation plane of the wheel (e.g., 525b_{R}), and the rotation axis of the wheel (e.g., 525b_{ω}) are rotated by an angle (e.g., ω₁) about the respective wheel-centerline (e.g., 525b_{c}) for steering of the mobile vessel (200).

With reference back to FIG. 5A, according to an exemplary embodiment of the present disclosure, the at least one passive wheel (e.g., 535) may be spring loaded so to provide necessary normal (to the casing) force to either lift the mobile vessel (200) off the bottom of the casing (180) when upside down or to provide friction for driving the mobile vessel (200) upwards slopes of the casing (200) and/or over slippery areas. According to an exemplary embodiment of the present disclosure, any one or more of the wheels (e.g., 525a, 525b, 535) may be spring loaded. According to an embodiment of the present disclosure, the combination of the relative placement of the wheel-centerlines (e.g., 525a_{c}, 525b_{c}, 535_{c}) with the centerline, C_{C}, of the casing (180), the offset, Δc, between the centerline, C_{V}, of the mobile vessel and the centerline, C_{V}, of the casing (180), and the steering of the wheels (e.g., 525a, 525b, 535) about the respective wheel-centerlines (e.g., 525a_{c}, 525b_{c}, 535_{c}), may allow the mobile vessel (200) to traverse the casing according to a helical path (e.g., spiral, corkscrew trajectory/path).

With further reference to FIG. 5A and FIG. 7A, according to an embodiment of the present disclosure, the drive/steering wheels (e.g., 525a, 525b) and the passive wheel (e.g., 535) may be grouped as one drive/steer unit arranged over a segment along the longitudinal extension (e.g., shown in FIG. 7A) of the mobile vessel (200). According to an embodiment of the present disclosure, a plurality of such drive/steer units may be arranged over a plurality of non-overlapping segments along the longitudinal extension of the mobile vessel (200). A number of such drive/steer units may be a function of a length/weight and/or a stability/traction requirement of the of the mobile vessel (200).

The mobile vessel (210, 220) according to the present disclosure may include one or more sensors (e.g., 250 and 260) integrated into the mobile vessel, including, for example, in the nose (220) of the mobile vessel as shown in FIG. 8A, and/or in the main body (210) of the mobile vessel as shown in FIG. 8B. In some cases, as shown in FIG. 8A, the sensors (250, 260) may be retractable into the mobile vessel. In such configuration, the sensors (250, 260) may remain in the retracted position so long sensing/measurements are not performed. For performing of the sensing/measurements, the sensors (250, 260) may be extended outwardly from the nose (220). Furthermore, it should be noted that the teachings according to the present disclosure may apply to any mobile vessel configured for immersion in harsh environments such as, for example, a downhole of a well, including the lateral section of the well (e.g., lateral section of welli shown in FIG. 1). In other words, the mobile vessel may not necessarily be a mobile robot with advanced technologies. Rather, it can be a simple submersion vessel (810) as shown in FIG. 8C fitted with drive and steering wheels according to the above description, the submersion vessel configured to be introduced/submersed into the fluid mixture of the downhole of a well or other.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A system for measuring properties of a fluid mixture in a casing of a downhole lateral section of a well, the system comprising:
a mobile vessel configured for submersion into the fluid mixture in the casing, the mobile vessel comprising:
a tubular shape that defines a centerline of the mobile vessel; and
a plurality of wheels having respective plurality of wheel-centerlines, the plurality of wheels protruding the tubular shape according to directions defined by the respective plurality of wheel-centerlines for contacting the casing,
wherein
each of the plurality of wheel-centerlines is configured to intersect a centerline of the casing, and
the centerline of the mobile vessel is configured to be at an offset from the centerline of the casing.

2. The system according to claim 1, wherein:
the offset is configured to provide the mobile vessel a clearance for traversing piles of debris and/or sand inside of the casing.

3. The system according to claim 1, wherein:
wherein during a traversal of the casing, the mobile vessel is orientated so that the centerline of the mobile vessel is farther away from a bottom of the casing compared to the centerline of the casing.

4. The system according to claim 1, wherein:
wherein during a traversal of the casing, the mobile vessel is orientated so that a vector representative of the offset is parallel to a gravity vector, g.

5. The system according to claim 1, wherein:
the plurality of wheels includes at least two drive wheels that rotate about respective rotation axes that are perpendicular to the respective wheel-centerlines.

6. The system according to claim 1, wherein:
the plurality of wheels includes at least one passive wheel that rotates about a respective rotation axis that is perpendicular to the respective wheel-centerline.

7. The system according to claim 6, wherein:
respective extensions of the at least two drive wheels along their respective wheel-centerlines are greater than an extension of the at least one passive wheel along its wheel-centerline.

8. The system according to claim 1, wherein:
wheels of the plurality of wheels are collocated along a longitudinal extension of the mobile vessel.

9. The system according to claim 8, wherein:
wheels of the plurality of wheels are arranged in a plurality group of wheels, and
wheels of each group of the plurality group of wheels are collocated along a respective longitudinal extension of the mobile vessel.

10. The system according to claim 9, wherein:
wheels of each group of the plurality group of wheels include at least two drive wheels and one passive wheel.

11. The system according to claim 1, wherein:
wheels of the plurality of wheels are located at different locations along a longitudinal extension of the mobile vessel.

12. The system according to claim 1, wherein:
the plurality of wheels includes at least two steering wheels that rotate about the respective wheel-centerlines.

13. The system according to claim 12, wherein:
wheels of the at least two steering wheels are drive wheels.

14. The system according to claim 1, wherein:
the mobile vessel further includes an orientation sensor, and
the mobile vessel uses measurements from the orientation sensor to control steering of the at least two steering wheels.

15. The system according to claim 1, wherein:
the mobile vessel controls steering of the at least two steering wheels to maintain a center of gravity of the mobile vessel above the centerline of the casing.

16. The system according to claim 1, wherein:
the mobile vessel controls steering of the at least two steering wheels to maintain the centerline of the mobile vessel above the centerline of the casing.

17. The system according to claim 1, wherein:
the mobile vessel controls steering of the at least two steering wheels to maintain a respective wheel-centerline of a reference wheel of the plurality of wheels at a reference direction.

18. The system according to claim 17, wherein:
the reference direction is a direction of a gravity vector, g.

19. The system according to claim 17, wherein:
the reference wheel is the at least one passive wheel.

20. The system according to claim 1, wherein:
the plurality of wheels includes
two drive wheels that rotate about respective rotation axes that are perpendicular to the respective wheel-centerlines, and
one passive wheel that rotates about the respective rotation axis that is perpendicular to the respective wheel-centerline,
the two drive wheels are steering wheels that that rotate about the respective wheel-centerlines,
a relative angular distance between the respective wheel-centerline of any of the two drive wheels and the wheel-centerline of the passive wheel is in a range from about 100° to about 115°, and
a relative angular distance between the respective wheel-centerlines of the two drive wheels is in a range from about 130° to about 160°.

21. The system according to claim 1, wherein:
the mobile vessel further includes a plurality of sensors for measuring of the properties of the fluid mixture.

22. The system according to claim 21, wherein:
the fluid mixture comprises gas, oil and water.

23. A mobile vessel for traversing a horizontal casing, the mobile vessel comprising:
a tubular shape that defines a centerline of the mobile vessel; and
a plurality of wheels having respective plurality of wheel-centerlines, the plurality of wheels protruding the tubular shape according to directions defined by the respective plurality of wheel-centerlines for contacting the horizontal casing,
wherein
each of the plurality of wheel-centerlines is configured to intersect a centerline of the horizontal casing,
the centerline of the mobile vessel is configured to be at an offset from the centerline of the horizontal casing,
the plurality of wheels includes at least two drive wheels that rotate about respective rotation axes that are perpendicular to the respective wheel-centerlines, and
the plurality of wheels includes at least one steering wheel that rotates about the respective wheel-centerline.

24. The mobile vessel according to claim 23, further comprising:
an orientation sensor that the mobile vessel uses to control steering of the at least one steering wheel to maintain a normal orientation of the mobile vessel during traversal of the horizontal casing, the normal orientation based on a vector representative of the offset being parallel to a gravity vector, g.

25. A method for traversing a casing that includes piles of debris and/or sand using a mobile vessel, the method comprising:
providing the mobile vessel according to claim 23;
integrating an orientation sensor in the mobile vessel;
activating the at least two drive wheels of the mobile vessel, thereby starting a traversal of the mobile vessel through the casing; and
based on measurements obtained from the orientation sensor, controlling the at least one steering wheel to guide the centerline of the mobile vessel above the centerline of the casing, thereby obtaining a normal orientation of the mobile vessel, the normal orientation based on a vector representative of an offset between centerlines of the mobile vessel and the casing being parallel to a gravity vector, g.
